(19) United States
(12) Patent Application Publication
(10) Pub. No.: US 2018/0288463 A1
(43) Pub. Date: Oct. 4, 2018

(54) ACTIVE MOCA GATEWAY SPLITTER

(71) Applicant: TIMES FIBER COMMUNICATIONS, INC., Wallingford, CT (US)

(72) Inventors: Brian J. Shapson, Millstone Township, NJ (US); Jay Shapson, Millstone Township, NJ (US); Matthew M. Shapson, Robbinsville, NJ (US); Robert L. Romerein, Peterborough (CA); Rong H. Li, Brooklyn, NY (US)

(21) Appl. No.: 15/806,411

(22) Filed: Nov. 8, 2017

Related U.S. Application Data
(63) Continuation-in-part of application No. 15/478,362, filed on Apr. 4, 2017.

(51) Int. Cl. H04N 21/426; H04N 21/61

(52) U.S. Cl. CPC H04N 21/426; H04N 21/6168

(57) ABSTRACT

An active MoCA (Multimedia over Coax Alliance) gateway splitter device, including a CATV input port for receiving a CATV input signal, an amplifier for amplifying the CATV signal, at least one MoCA port (connectable to a MoCA device), a plurality of modem/gateway ports (each connectable to a modem or gateway device); and a diplex filter that includes a low-pass filter section and a high-pass filter section. The CATV input port is electrically connected to the modem/gateway ports via the low-pass filter section and the MoCA port is electrically connected to the modem/gateway ports via the high-pass filter section. Accordingly, the MoCA device can communicate bidirectionally with the modem/gateway devices over a higher frequency band, the modem/gateway devices can communicate bidirectionally with the CATV input port over a lower frequency band, and the MoCA device is electrically isolated from the CATV input port.

### CROSS REFERENCE TO RELATED APPLICATIONS

This application is a continuation-in-part of U.S. patent application Ser. No. 15/478,362, filed Apr. 4, 2017, which is related to U.S. patent application Ser. No. 13/868,261, now U.S. Pat. No. 8,752,114, filed on Apr. 23, 2013, and U.S. patent application Ser. No. 14/120,054, now U.S. Pat. No. 9,356,796, filed on Apr. 21, 2014, the entire contents of which are hereby incorporated by reference.

### FIELD OF THE INVENTION

The present invention applies broadly to cable television devices, and more specifically to cable television devices associated with receiving a cable television (CATV) signal, and distributing the same to a plurality of modem/gateway devices, one or more Multimedia over Coax Alliance (MoCA) devices, and legacy devices such as television sets.

### BACKGROUND

Typical cable television (CATV) systems provide for sharing a common coaxial medium and permit various users in the system to communicate with the headend of the system, where the CATV signals originate, but not with each other (due to the directionality of signal flow imposed by the requirement that the various users be signal isolated from one another).

In recent years, Multimedia over Coax Alliance (MoCA) systems have been developed that operate in a different frequency spectrum or band than CATV systems. MoCA systems are designed to communicate bilaterally with each other, meaning that any port of a MoCA system device serves both an input and output port. MoCA devices are typically located within a home or building for permitting users therein to communicate with a single or dedicated MoCA networking device that provides functionality for each user to selectively record a television program for later viewing. It is important in such MoCA systems to keep the CATV input signals wholly isolated from the MoCA signals within the system. More specifically, one portion of such systems permit typical CATV signals to be connected to individual devices such as television sets, cable boxes, and so forth, in a standard manner, whereby all standard CATV signal ports are isolated from all MoCA ports in the system, as previously mentioned.

Cable gateway devices have the capability to communicate with the CATV headend in the CATV signal band, which is typically 5 to 1002 MHz (megahertz), and to communicate with MoCA devices in the MoCA frequency band, which is typically 1125 to 1675 MHz. Accordingly, such cable gateway devices permit information that is transmitted through a public CATV system to be shared amongst MoCA device users joined in a private network within a commercial or residential building. Such cable gateway devices permit CATV signals to be rebroadcast within a different frequency band via connections controlled through typically digital logic means, completely avoiding the use of physical switching or movement of cables between certain ports.

U.S. Pat. Nos. 8,752,114 and 9,356,976 describe a CATV/MoCA signal distribution system that provides the functionality described above. However, in order to electrically connect to more than one gateway or modem port, that CATV/MoCA signal distribution system requires multiple diplex filters that have many discrete parts that take up a lot of space on a circuit board, including many inductors that require tuning to establish the desired filter cutoff and transmission characteristics.

There is a need in the art for simplified and cost effective cable gateway splitters that isolate the CATV and MoCA bands, insuring that MoCA band signals cannot become involved with the CATV signals.

### SUMMARY

U.S. patent application Ser. No. 15/478,362 discloses a passive gateway device that avoids a direct signal path between a CATV signal input port and MoCA client or user input/output ports, permitting users in a building to connect a CATV signal to various TV sets, modems, and so forth, while at the same time permitting bidirectional communication between a plurality of users of individual in-home media devices within a building (e.g., multi-room digital video recording devices, gateway recording devices, multi-layer gaming devices, high speed data devices), each connected through a coaxial cable network terminated at the output ports of the invention and utilizing the RF spectrum allocated to Multimedia over Coax Alliance (MoCA). Notably, the MoCA gateway splitters disclosed in U.S. patent application Ser. No. 15/478,362 simplify the circuitry of the previous MoCA gateway splitters by utilizing only one diplex filter to integrate a plurality of modem/gateway devices. The single diplex filter may be a solid-state ceramic filter to further reduce the production labor required to tune the splitter consistently and efficiently.

While passive splitters like those disclosed in U.S. patent application Ser. No. 15/478,362 have their advantages, in some instances the CATV system may not provide a sufficient RF level to satisfy the needs of the modem/gateway devices. Accordingly, there is a need for additional improvements to the MoCA gateway splitters described in U.S. patent application Ser. No. 15/478,362.

In order to overcome the disadvantages of the prior art and the parent application, there is provided an active MoCA (Multimedia over Coax Alliance) gateway splitter device that includes a CATV input port for receiving a CATV input signal, an amplifier for amplifying the CATV signal, at least one MoCA port (connectable to a MoCA device), a plurality of modem/gateway ports (each connectable to a modem or gateway device); and a diplex filter that includes a low-pass filter section and a high-pass filter section. The CATV input port is electrically connected to the modem/gateway ports via the low-pass filter section and the MoCA port is electrically connected to the modem/gateway ports via the high-pass filter section. Accordingly, the MoCA device can communicate bidirectionally with the modem/gateway devices over a higher frequency band, the modem/gateway devices can communicate bidirectionally with the CATV input port over a lower frequency band, and the MoCA device is electrically isolated from the CATV input port.

By amplifying the CATV input signal, the active MoCA gateway splitter enables reliable communication with a media service provider (e.g., a CATV headend) even when signal levels at the installation location are not sufficient (for example, due to the topology of the distribution network).

### BRIEF DESCRIPTION OF THE DRAWINGS

Various embodiments of the present invention are described with reference to the drawings, in which like items are identified by the same reference designation. FIGS. 1-7, 8A, and 9-11 illustrate the passive MoCA gateway splitters described in U.S. patent application Ser. No. 15/478,362. FIG. 8B illustrates an additional passive MoCA gateway splitter. FIGS. 12-13 illustrate active MoCA gateway splitters according to exemplary embodiments of the present invention.

FIG. 1 is a block diagram illustrating a MoCA gateway splitter according to the simplest embodiment.

FIG. 2 is a block diagram illustrating a MoCA gateway splitter according to another exemplary embodiment.

FIG. 3 is a block diagram illustrating a MoCA gateway splitter according to another exemplary embodiment.

FIG. 4 is a block diagram illustrating a MoCA gateway splitter according to another exemplary embodiment.

FIG. 5 is a schematic circuit diagram illustrating 2-way hybrid splitters according to an exemplary embodiment.

FIG. 6 is a schematic circuit diagram illustrating a 5-way resistive splitter according to an exemplary embodiment.

FIG. 7 is a schematic circuit diagram illustrating a diplex filter according to an exemplary embodiment.

FIG. 8A is a schematic circuit diagram illustrating the MoCA gateway splitter illustrated in FIG. 4 according to an exemplary embodiment.

FIG. 8B is a schematic circuit diagram illustrating the MoCA gateway splitter according to another exemplary embodiment.

FIG. 9 is a schematic circuit diagram illustrating a MoCA gateway splitter according to another exemplary embodiment.

FIG. 10 is a schematic circuit diagram illustrating a MoCA gateway splitter according to another exemplary embodiment.

FIG. 11 is a view of an assembled MoCA gateway splitter according to an exemplary embodiment.

FIG. 12 is a block diagram illustrating an active MoCA gateway splitter 1200 according to an exemplary embodiment of the present invention.

FIGS. 13A and 13B are schematic circuit diagrams illustrating an active MoCA gateway splitter 1300 according to another exemplary embodiment of the present invention.

### DETAILED DESCRIPTION

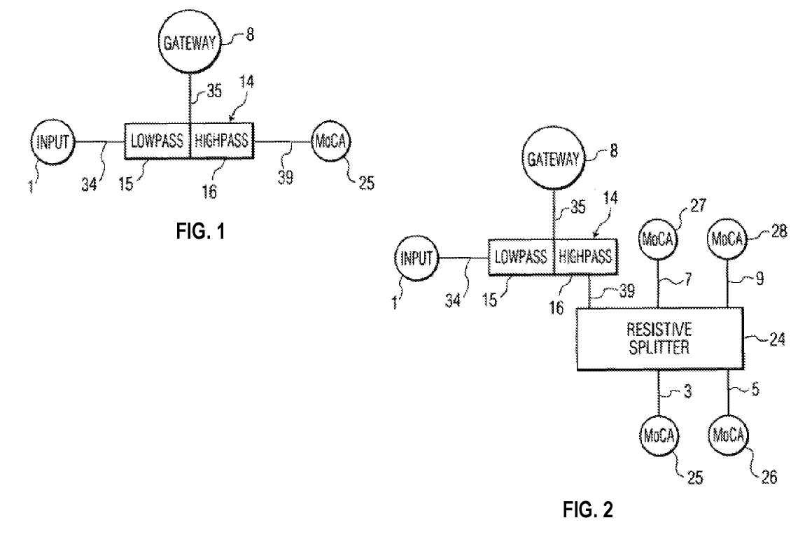

FIG. 1 is a block diagram illustrating a MoCA gateway splitter according to the simplest embodiment.

As shown in FIG. 1, a diplex filter 14 has a low pass section 15 that is electrically connected to CATV input 1 via conductive path 34. The diplex filter 14 also has a high-pass section 16 connected to MoCA port 25 via conductive signal path 39. The diplex filter 14 also has a connection between the low-pass 15 and high-pass 16 sections that is electrically connected to gateway/modem port 8 via conductive signal path 35. This arrangement allows gateway/modem port 8 to communicate bidirectionally with the CATV port 1 in a lower frequency band (for example, 5 to 1002 MHz). This arrangement also allows a modem or gateway device connected to the gateway/modem port 8 to communicate bidirectionally with the MoCA port 25 in a higher frequency band (for example, 1125 MHz to 1675 MHz as the MoCA band is currently defined). However, a MoCA device connected to the MoCA port 25 cannot communicate with the CATV input port 2 due to the high attenuation between these two frequency bands through the diplex filter 14. It should be noted that as the CATV band evolves and changes its boundary frequencies (for example, to 5-1218 MHz), the MoCA band boundaries must also change. These changes are anticipated by changing the component values of the diplex filter according to formulas known to those skillful in the art.

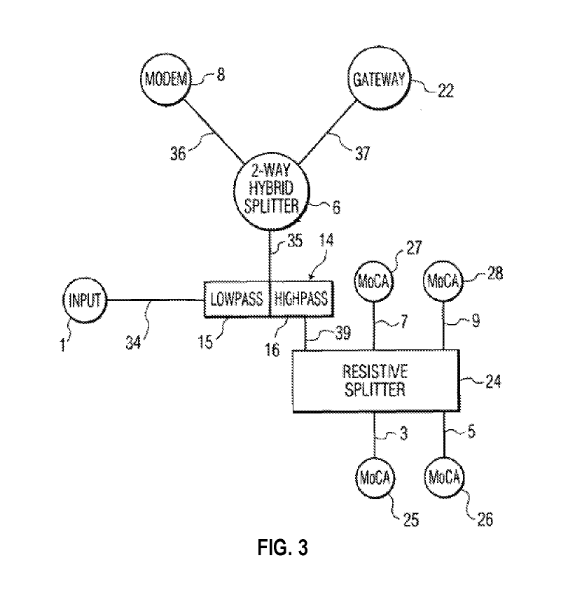

FIG. 2 is a block diagram illustrating a MoCA gateway splitter according to an exemplary embodiment.

As shown in FIG. 2, the output of the high-pass section 16 of diplex filter 14 is connected via conductive path 39 to the input of resistive splitter 24. Since a plurality of MoCA devices are typically deployed in a MoCA network, ports 25, 26, 27, and 28 are connected to a plurality of MoCA devices to form a bidirectional communication network between each other through resistive splitter 24 and a modem/gateway device connected to the modem port 8 through the high-pass section 16 of the diplex filter 14. The MoCA port 25 is electrically connected to the resistive splitter 24 via conductive path 3, the MoCA port 26 is electrically connected to the resistive splitter 24 via conductive path 5, the MoCA port 27 is electrically connected to the resistive splitter 24 via conductive path 7, and the MoCA port 28 is electrically connected to the resistive splitter 24 via conductive path 9. The resistive splitter 24 can be expanded to create larger networks of 6 or 8 MoCA devices, for example, that can bidirectionally communicate with each other and the modem/gateway device at the modem port 8.

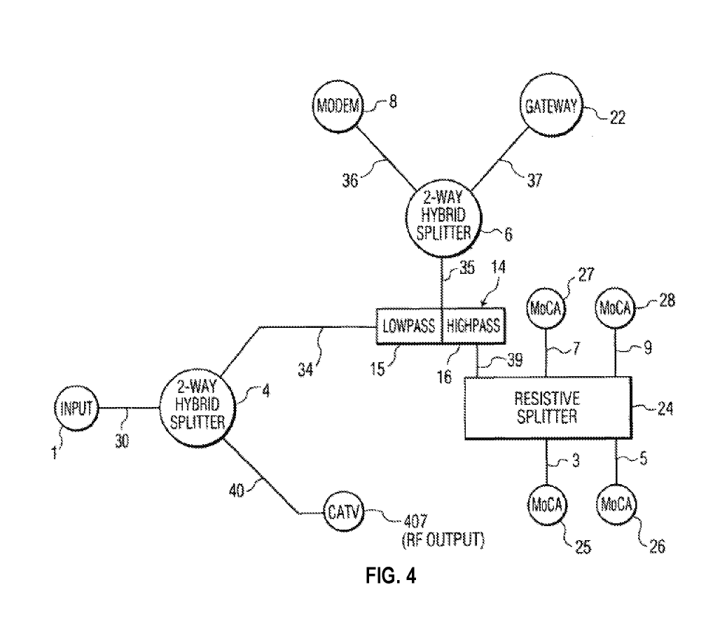

FIG. 3 is a block diagram illustrating a MoCA gateway splitter according to another exemplary embodiment.

As shown in FIG. 3, a 2-way splitter 6, of either resistive or hybrid design, is connected to the common port of the diplex filter 14 via the conductive path 35. The outputs of the splitter 6 are connected to the modem port 8 via conductive path 36 and a gateway port 22 via conductive path 37. (As one of ordinary skill in the art would recognize, this arrangement is not limited to two modem/gateway devices. Instead, the 2-way splitter 6 may be replaced with a splitter with a larger number of ports to allow more than two modem/gateway devices to access the common port of the diplex filter 14.)

As described above, previous generations of MoCA gateway splitters have included a diplex filter for each gateway or modem port. As shown in FIG. 3, the present invention allows MoCA devices (connected to the MoCA ports 25-28) to communicate bidirectionally with a plurality of modem and/or gateway devices (e.g., a modem connected to the modem port 8 and a gateway device connected to the gateway port 22) using a single diplex filter.

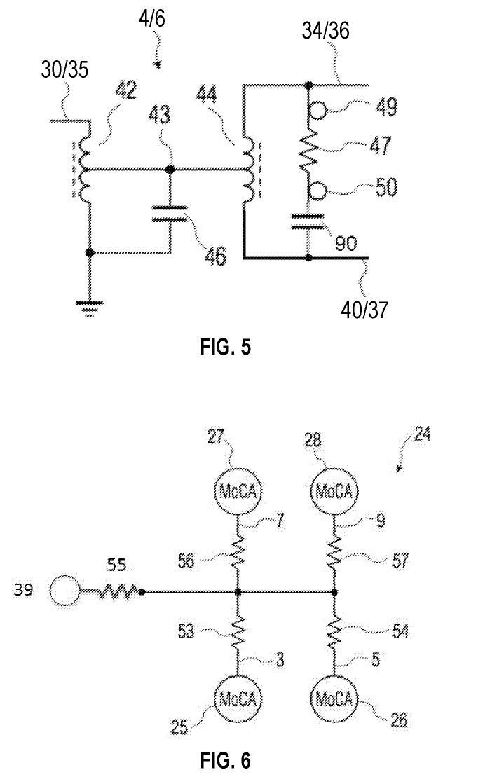

FIG. 4 is a block diagram illustrating a MoCA gateway splitter according to another exemplary embodiment of the present invention.

As shown in FIG. 4, the input of a 2-way hybrid splitter 4 is connected to the CATV input port 1 via conductive path 30. The first output of the hybrid splitter 4 is connected to the low-pass section 15 of the diplex filter 14 via the conductive path 34. The second output of the hybrid splitter 4 is connected to an RF port 407 via conductive path 40. In this way, legacy CATV devices like televisions and set top converters can be connected to the RF port 407 and integrated with the home network through the MoCA gateway splitter.

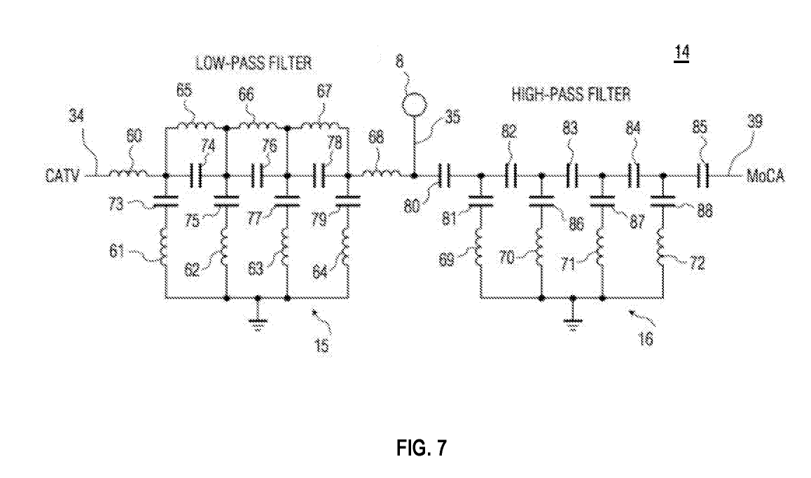

FIG. 5 is a schematic circuit diagram illustrating the 2-way hybrid splitters 4 and 6 according to an exemplary embodiment.

As shown in FIG. 5, the 2-way hybrid splitter 4(6) includes a matching transformer having a primary winding 42 with one end individually connected to an electrically conductive path 30(35), with the other end of the winding 42 being connected to ground. The splitter 4(6) also includes a secondary winding 44 having one end individually connected to electrically conductive paths 34(36), respectively, and another end connected to electrically conductive paths 40(37). In this example, the primary winding 42 has a turns ratio of 2:5 relative to a center tap 43 connected between the primary winding 42 and the secondary winding 44. The secondary winding 44 has a turns ratio of 2:2 relative to the center tap 43. A capacitor 46 is connected between the center tap and ground to match the leakage inductance inherent in the interconnection of the transformer windings 42 and 44. A series circuit of a resistor 47 and two inductors 49 and 50, sometimes realized in the traces of the circuit board, are connected across the secondary winding 44 as shown. Note that the inductors 49 and 50 are chokes that modify the phase cancellation at the very high end of the frequency band of signals outputted from either of the splitter 4. The resistor 47, in combination with the chokes 49 and 50 sets the phase cancellation between the two output lines from the secondary winding 44 in order to maximize the electrical isolation there between. A capacitor 90 in series with the phase cancellation circuit described above tunes the phase cancellation at the low end of the spectrum to improve the signal isolation between the two outputs. Note that the capacitance of the capacitor 46 is typically 1 pF (picofarads), the chokes 49 and 50 typically have inductances of 5 nH (nanohenries), and resistor 47 typically has a resistance between 180 and 220 ohms. Capacitor 90 typically has a capacitance of 1000 pF.

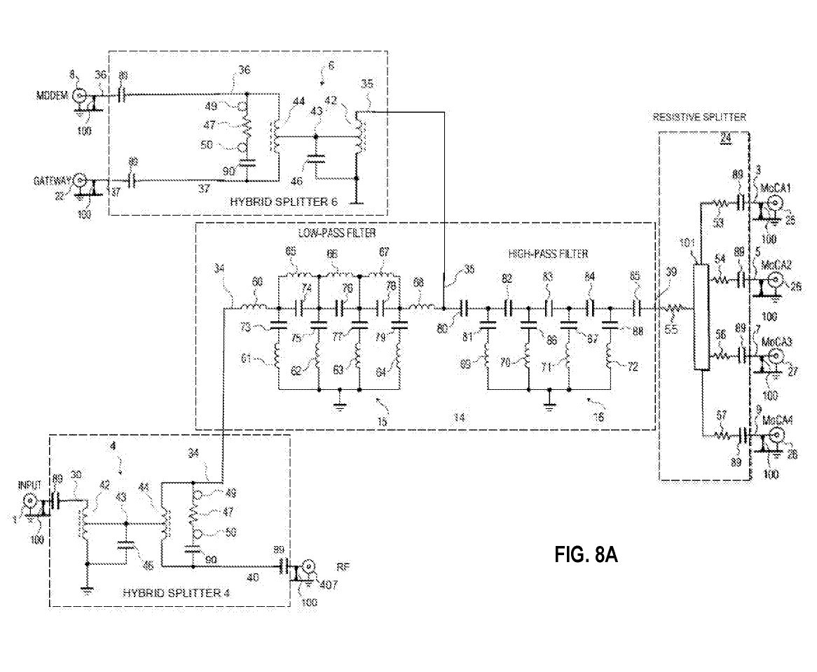

FIG. 6 is a schematic circuit diagram illustrating the 5-way resistive splitter 24 according to an exemplary embodiment.

As shown in FIG. 6, five resistors 53 through 57 each have one end connected in common. The other end of resistor 55 is connected to the high-pass filter section 16 of the diplex filter 14 via the electrically conductive circuit path 39. The other end of resistor 53 is connected to the MoCA terminal 25 via electrically conductive path 3. The other end of resistor 54 is connected to the MoCA terminal 26 via electrically circuit path 5. The other end of resistor 56 is connected to the MoCA terminal 27 via electrically conductive path 7. The other end of resistor 57 is connected to the MoCA terminal 28 via electrically conductive path 9.

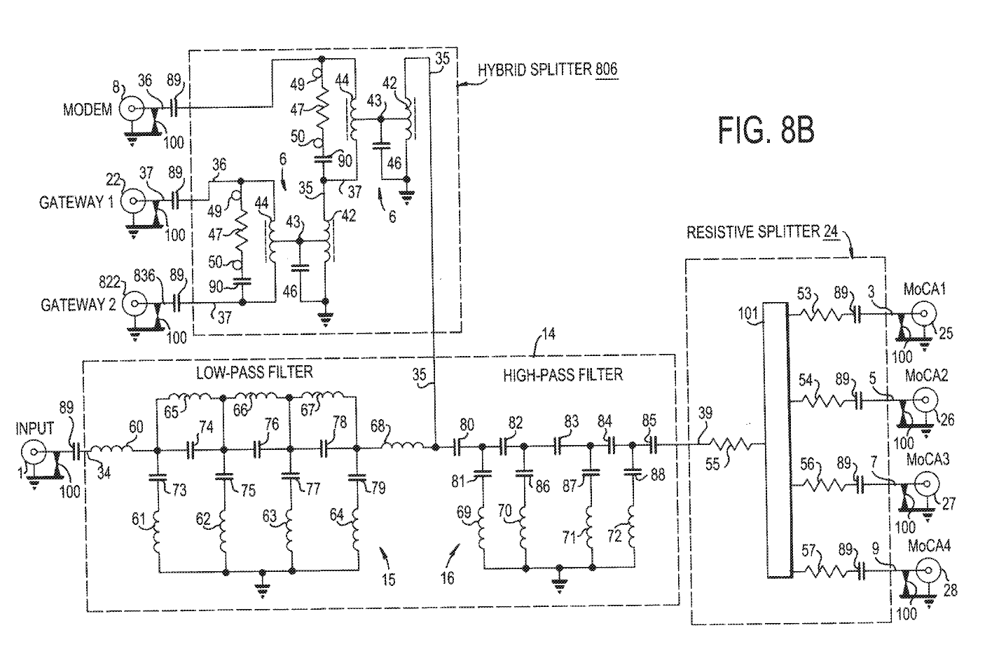

FIG. 7 is a schematic circuit diagram illustrating the diplex filter 14 according to an exemplary embodiment.

As shown in FIG. 7, the diplex filter 14 includes a plurality of inductors 60 through 72, and a plurality of capacitors 73 through 88, connected in series and parallel circuit combinations as shown. Values of the aforesaid inductors and capacitors are selected for obtaining the required low-pass filter frequency range, and high-pass filter frequency range, as previously indicated.

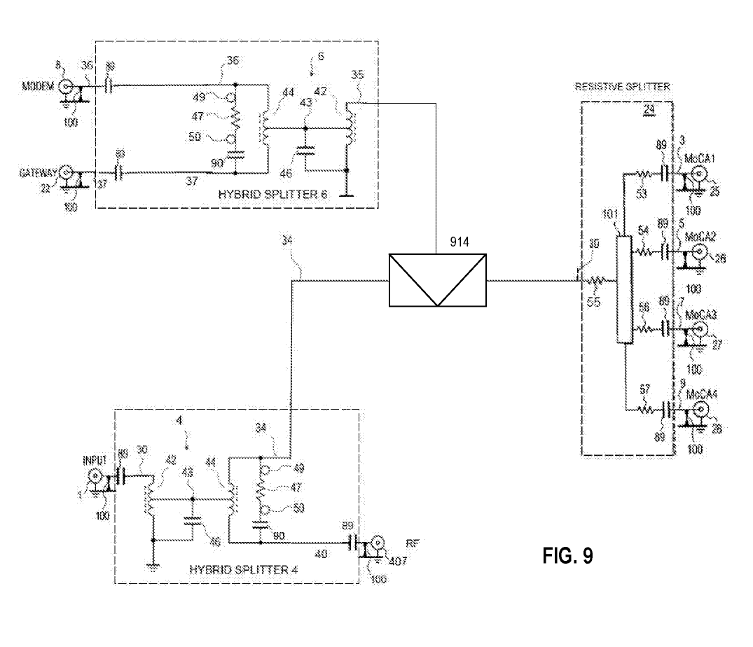

FIG. 8A is a schematic circuit diagram illustrating the MoCA gateway splitter illustrated in FIG. 4 according to an exemplary embodiment.

The MoCA gateway splitter illustrated in FIG. 8A is similar to the MoCA gateway splitter illustrated in FIG. 4, including the 2-way hybrid splitters 4 and 6 illustrated in FIG. 5, the four-way resistive splitter 24 illustrated in FIG. 6, and the diplex filter 14 illustrated in FIG. 7. The embodiment illustrated in FIG. 8A also includes additional components. More specifically, spark gaps 100 have been connected individually between ground and each of the input port 1, the CATV port 7, the modem port 8, the gateway port 22, the MoCA port 25, the MoCA port 26, the MoCA port 27, and the MoCA port 28, respectively. Note that use of the terminology port is meant to be also analogous to a terminal, whereby typically each of the aforesaid ports are coaxial connector ports. Also, as shown, DC blocking capacitors 89 have been added to the 2-way hybrid splitters 4 and 6 and the 5-way resistive splitter 24, each of the blocking capacitors 89 being connected as shown. In the 5-way resistive splitter 24, a connection pad 101 has been included in order to provide a common connection node for all of the resistors of the resistive splitter 24. The connection pad 101 is large enough to provide a low impedance node via the copper material of the pad providing body capacitance on a dielectric PC Board substrate. If the MoCA ports 25 through 28 are all terminated to MoCA device ports each having a 75-ohm input impedance, the characteristic impedance at pad or node 101 will be 25.2 ohms. In this example, as is typical with CATV systems, the impedance at the various ports is 75 ohms.

In the 2-way hybrid splitters 4 and 6, two capacitors 46 may be used in parallel between the ferrite transformer windings 42 and 44 to obtain a more distributed ground connection (not shown). The capacitors 46 provide for canceling small amounts of stray inductance in the interconnection between the ferrite core transformers 42 and 44, for improving high frequency return loss, and for isolation there between. The resistors 47 of the 2-way hybrid splitters 4 and 6 preferably have resistance of 180 ohms, but can have a resistance range of 150 ohms to 220 ohms depending on the characteristics of the particular ferrite core transformers 42 and 44 at low frequencies (e.g., between 5 MHz and 50 MHz). The capacitors 90 improve isolation and return loss at low frequencies.

The DC blocking capacitors 89 may each have a capacitance of 2200 pF (picofarads) and a voltage rating of 1000 volts. In the 2-way hybrid splitter circuits 4 and 6, the tapoff 43 for the ferrite core transformer 42 may be between the second turn and the fifth turn of the seven turns thereof. In the ferrite core transformer 44, the tapoff 43 may be between the second turn from each end of the four turns included. The capacitors 90 may each have a capacitance of 1000 pF. The capacitors 46 may each have a capacitance of 1 pF.

FIG. 8B is a schematic circuit diagram illustrating the MoCA gateway splitter according to another exemplary embodiment.

The MoCA gateway splitter shown in FIG. 8B is similar to the MoCA gateway splitter shown in FIG. 8A, except that it includes an additional gateway port 822 connected to an electrically conductive path 836. In order to accommodate the additional gateway port 822, the MoCA gateway splitter includes a 3-way hybrid splitter 806, which includes two hybrid splitters 6 that connect the three electrically conductive paths 36, 37, and 836 to the common port of the diplex filter 14 via the electrically conductive path 35.

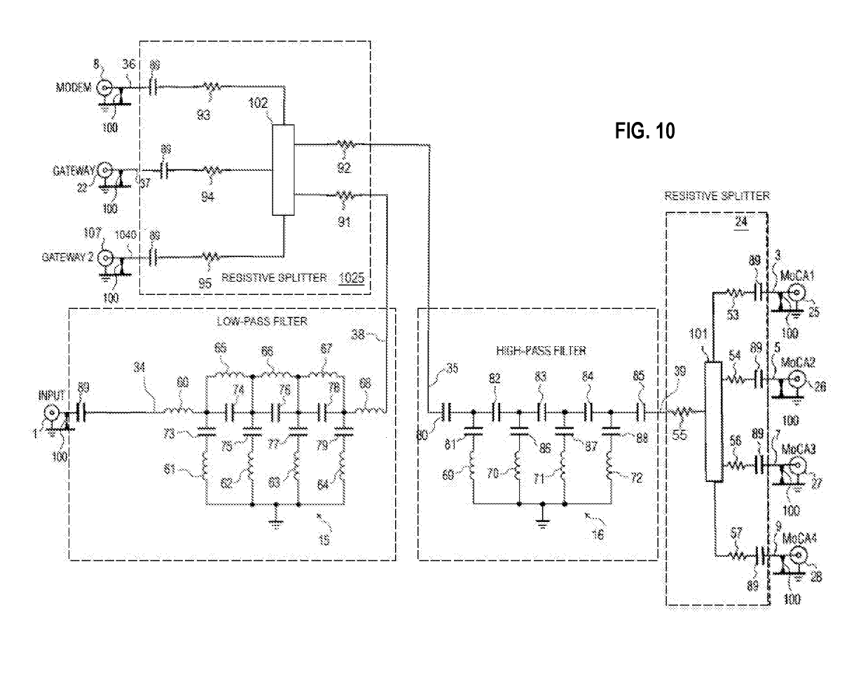

FIG. 9 is a schematic circuit diagram illustrating a MoCA gateway splitter according to another exemplary embodiment.

The MoCA gateway splitter illustrated in FIG. 9 is similar to the MoCA gateway splitter illustrated in FIG. 8, except that the conventional diplex filter 14 is replaced with a ceramic or solid-state diplex filter 914. The diplex filter 914 may be, for example, co-fired ceramic device (e.g., a low temperature co-fired ceramic device) with inductors and capacitors (in the same or similar arrangement as the inductors and capacitors of the diplex filter 14 shown in FIGS. 7 and 8) etched into the ceramic layers.

Co-fired ceramic devices are monolithic, ceramic microelectronic devices where the entire ceramic support structure and any conductive, resistive, and dielectric materials are fired in a kiln at the same time. In contrast to conventional semiconductor devices, where layers are processed serially with each new layer being fabricated on top of previous layers, co-fired ceramic are made by processing a number of layers independently and assembling them into a device as a final step. The diplex filter 914 may be, for example, a HMD024A-T filter made by Soshin.

When compared to a conventional discrete-element diplex filters (such as the diplex filter 14 shown in FIGS. 7 and 8), ceramic or solid-state filters (such as the diplex filter 914) simplify the production of the MoCA gateway splitter and increase the economic viability of product. Conventional diplex filters have many discrete parts. Most of the inductors require tuning to establish the desired filter cutoff and transmission characteristics. A ceramic or solid-state diplex filter, on the other hand, occupies a small fraction of the circuit board area and requires no tuning.

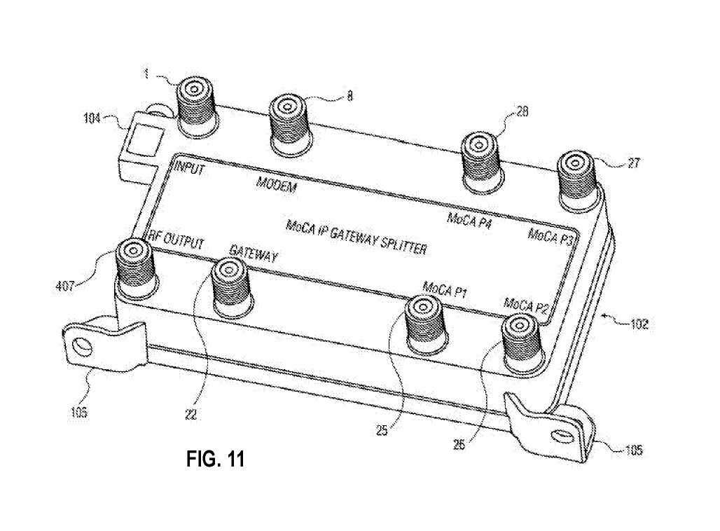

FIG. 10 is a schematic circuit diagram illustrating a MoCA gateway splitter according to another exemplary embodiment.

The MoCA gateway splitter illustrated in FIG. 10 is similar to the MoCA gateway splitter illustrated in FIG. 8, except that the MoCA gateway splitter illustrated in FIG. 10 has three modem/gateway ports (8, 22, and 107) and no RF port 7. The input port 1 connects to the input of the low-pass filter 15 (rather than a hybrid splitter). Also, the hybrid splitter 6 in FIG. 8 has been replaced with 5-way resistive splitter 1025. Similar to the 5-way resistive splitter 24, the 5-way resistive splitter 1025 includes resistors 91-95 and a connection pad 102. The 5-way resistive splitter 1025 may also include DC blocking capacitors 89. The gateway port 107 is electrically connected to the resistive splitter 1025 via conductive path 1040.

Additionally, the output of the low-pass filter 15 at inductor 68 is electrically connected to the resistive splitter 125 via conductive path 38 and the input of the high-pass filter 16 at capacitor 80 is connected to a separate ports of the resistive splitter 1025 via the conductive path 35. This allows more freedom in the layout and less interaction of component values in the cross-over frequency region between 1002 MHz and 1125 MHz. Note that modem and gateway devices are equivalent in that they both communicate bidirectionally with the CATV system in the lower portion of the spectrum, and they communicate bidirectionally with the MoCA devices in the upper portion of the spectrum.

In the embodiment shown in FIG. 10, the DC blocking capacitors 89 are typically 4700 pF with a 1000-volt breakdown rating.

In the low-pass filter section 15, the inductors 61, 62, 63, and 64 may each have a 0.3 mm (millimeter) wire diameter, a 1.5 mm coil diameter, and 2.5 turns. The capacitors 74, 76, and 78 may each have a capacitance of 0.75 pF. The inductors 65, 66, and 67 may each have a 0.3 mm wire diameter, 1.7 mm coil diameter, and 2.5 turns, respectively. The capacitors 73 and 75 may each have a capacitance of 1.8 pF. The capacitors 77 and 79 may each have a capacitance of 1.8 pF. The inductor 68 may have a 0.3 mm wire diameter, a 2.0 mm coil diameter, and 2.5 turns.

In the high-pass filter section 16, the capacitor 80 may have a capacitance of 1.2 pF. The capacitors 82, 86, and 87 may each have a capacitance of 1.8 pF, respectively. The capacitor 81 may have a capacitance of 2.2 pF. The capacitor 83 may have a capacitance of 2.0 pF. The capacitor 84 may have a capacitance of 1.5 pF. The capacitor 85 may have a capacitance of 6.8 pF. The capacitor 88 may have a capacitance of 2.5 pF. The inductor 69 may have a 0.3 mm wire diameter, a 1.5 mm coil diameter, and 2.5 turns. The inductors 70, 71 and 72 may each have a 0.3 mm wire diameter, a 1.7 mm coil diameter, and 2.5 turns.

In the 5-way resistive splitter 24, each of the resistors 53 through 57 may have a resistance of 51 ohms. In the 5-way splitter 1025, each of the resistors 91 through 95 may each have a resistance of 47 ohms since four of the ports are terminated through the low-pass filter 15, and four of the ports are terminated through high-pass filter 16. This choice of resistor values, being different than the case of resistive splitter 24, insures that the modem/gateway ports will have a characteristic impedance of 75 ohms in the low-pass and the high-pass spectra.

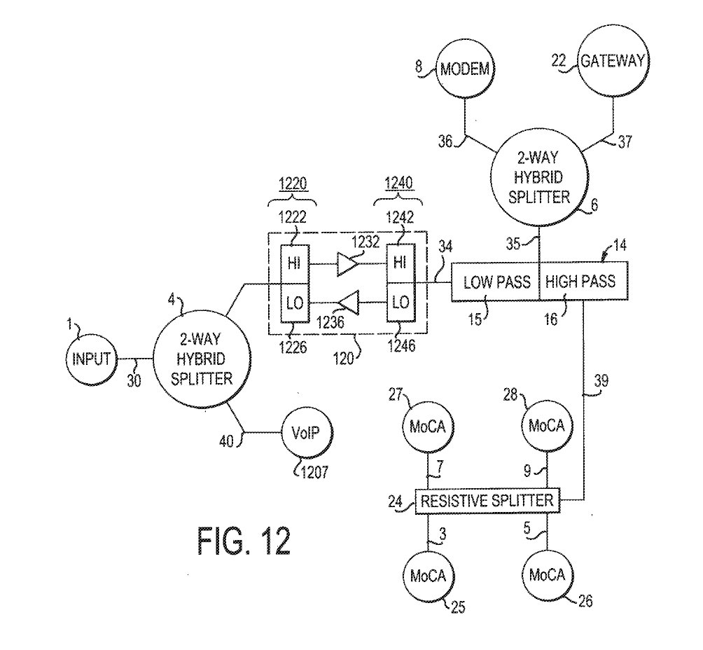

FIG. 11 is a view of an assembled MoCA gateway splitter according to an exemplary embodiment.

As shown in FIG. 11, the MoCA gateway splitter includes a housing 102 with the MoCA ports 25 through 28 at one end and the input port 1, the modem port 8, the RF output port 407, and the gateway port 22 at an opposite end. (As shown in FIG. 11, the MoCA gateway splitter includes an RF output port 407 as illustrated, for example, in FIGS. 8 and 9. Alternatively, of course, the RF output port 407 may be replaced with a gateway port 107 as illustrated, for example, in FIG. 10). Also shown is a ground terminal 104 for receiving a ground connection. Screw receptive brackets 105 are provided for securing the gateway splitter to a desired seating surface, such as a mounting base within a cavity or enclosure (not shown).

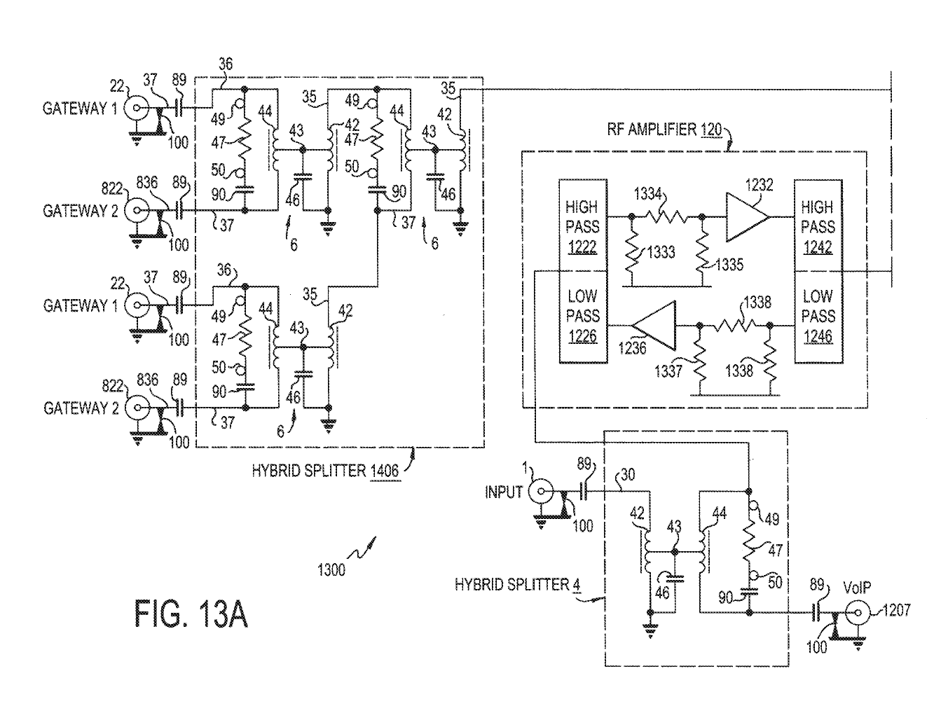

FIG. 12 is a block diagram illustrating an active MoCA gateway splitter 1200 according to an exemplary embodiment of the present invention.

The active MoCA gateway splitter 1200 includes many of the features described above, including a diplex filter 14 (or solid state diplex filter 914) with a low pass section 15 that is electrically connected to a CATV input 1 via a conductive path 34, a high-pass section 16 connected to a MoCA port 25 via a conductive signal path 39 (or multiple MoCA ports 25-28 connected, e.g., via a resistive splitter 24 and signal paths 3, 5, 7, and 9), and a connection between the low-pass 15 and high-pass 16 sections that is electrically connected to gateway/modem port 8 via conductive signal path 35 (or multiple modem/gateway ports 8 and 22 connected via hybrid splitter(s) 6 and signal paths 35, 36, 37, etc.).

Additionally, the active MoCA gateway splitter 1200 includes an amplifier 120 to communicate more reliably with the media service provider (e.g., the CATV headend) when signal levels at the installation location are not sufficient (for example, due to the topology of the distribution network). As shown in FIG. 12, the amplifier 120 may be situated between the 2-way hybrid splitter 4 at the CATV input 1 and the low pass section 15 of the MoCA diplex filter 14/914. The amplifier 120 may be a bidirectional amplifier 120 that includes an input diplex filter 1220 (with a high-pass section 1222 and a low-pass section 1226), output diplex filter 1240 (with a high-pass section 1242 and a low-pass section 1246), a forward path amplifier 1232 for the forward CATV band connected between the high-pass sections 1222 and 1242 of the diplex filters 1220 and 1240, and a amplifier 1236 for the reverse band connected between the low-pass sections 1226 and 1246 of the diplex filters 1220 and 1240.

The forward path (from the CATV port 1 to the diplex filter 14/914) is typically from 54, 85, or 102 MHz to 1002 or 1218 MHz. The amplifier 120 may amplify the forward path signal so that the net loss from the CATV port 1 to the modem/gateway ports 8, 22, etc. is about 0 dB (decibels). The signal level compensation provided by the amplifier 120 guarantees that the gateway devices will work in any installation situation, regardless of the input signal levels. In embodiments where the amplifier 120 is a bidirectional amplifier and includes diplex filters 1220 and 1240, the amplification of the forward path is performed by the amplifier 1232 between the high-pass sections 1222 and 1242, which have a cutoff frequency below the frequency band of the forward path.

The reverse path (from the diplex filter 14/914 to the CATV port 1) is typically from 5 MHZ to 42, 65, or 85 MHz. Amplification of the forward path signal adds loss to the return path. Accordingly, the amplifier 120 may be a bidirectional amplifier. In those embodiments, the low-pass sections 1222 and 1242 have a cutoff frequency above the frequency band of the forward path and the amplifier 1236 may amplify the reverse path so that the net loss from the gateway ports 8, 22, etc. to the input port 1 is about 0 dB. The signal level compensation provided by the amplifier 1236 enables modem/gateway communication between the modem or gateway device(s) and the CATV system.

The active MoCA gateway splitter 1200 may also include a passive VoIP (Voice over Internet Protocol) port 407 to ensure a reliable VoIP connection that is immune to power failure. As shown in FIG. 12, for example, the active MoCA gateway splitter 1200 may include a 2-way hybrid splitter 4 with an input connected to the CATV input port 1 via conductive path 30, a first output connected the amplifier 120 via the conductive path 1234, and a second output connected to the passive VoIP port 407 via conductive path 40.

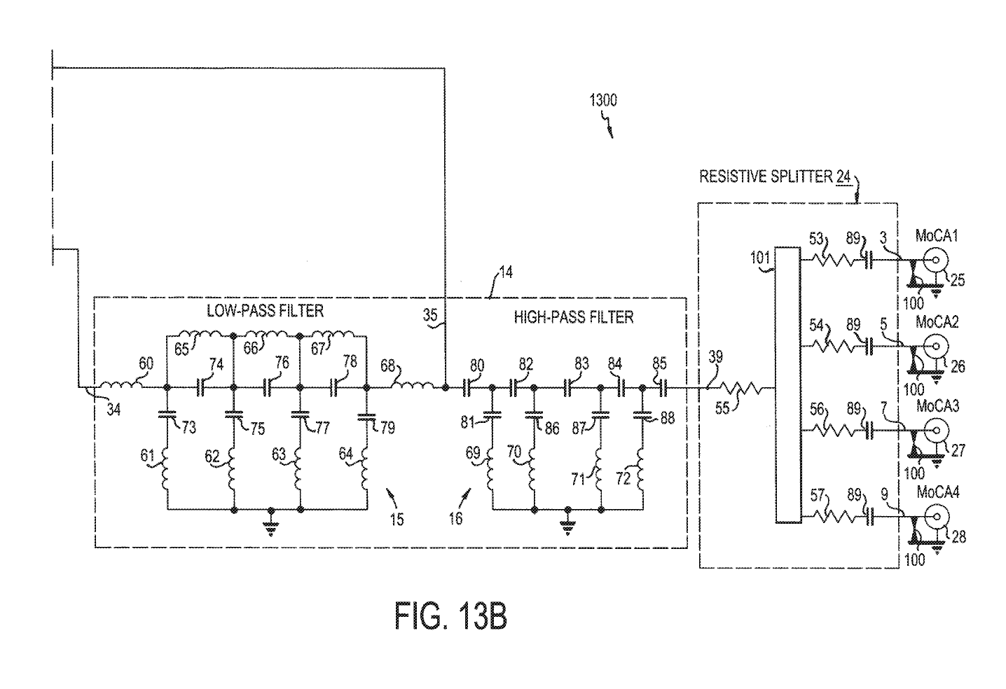

FIGS. 13A and 13B are schematic circuit diagrams illustrating an active MoCA gateway splitter 1300 according to another exemplary embodiment of the present invention. The active MoCA gateway splitter 1300 is similar to the active MoCA gateway splitter 1300 in that it includes a hybrid a 2-way hybrid splitter 4 with an input connected to the CATV input port 1 via conductive path 30, a first output connected the amplifier 120 via the conductive path 1234, and a second output connected to the passive VoIP port 407 via conductive path 40; a diplex filter 14 with a low pass section 15 that is electrically connected to a CATV input 1 via a conductive path 34, a high-pass section 16 connected to multiple MoCA ports 25-28 via a resistive splitter 24 and signal paths 3, 5, 7, and 9, and a connection between the low-pass 15 and high-pass 16 sections that is electrically connected multiple modem/gateway ports. In this embodiment, active MoCA gateway splitter 1300 includes four gateway ports 1321-1324 electrically connected to a four-way hybrid splitter 1306 via signal paths 1331-1334.

The hybrid splitter 4 is described above with reference to FIG. 5, the diplex filter 14 is described above with reference to FIG. 7, the resistive splitter 24 is described above with reference to FIG. 6, and the four-way hybrid splitter 1406 includes three 2-way hybrid splitter 6 (described above with reference to FIG. 5) arranged as shown in FIG. 13A. In other embodiments, the diplex filter 14 may be a solid state or ceramic diplex filter 914, as described above with reference to FIG. 8.

The amplifier 120 includes an input diplex filter 1220 (with a high-pass section 1222 and a low-pass section 1226), output diplex filter 1240 (with a high-pass section 1242 and a low-pass section 1246), an amplifier 1232 (with resistors 1333, 1334, and 1335) for the forward CATV band connected between the high-pass sections 1222 and 1242 of the diplex filters 1220 and 1240, and an amplifier 1236 (with resistors 1337, 1338, and 1339) for the reverse band connected between the low-pass sections 1226 and 1246 of the diplex filters 1220 and 1240. The resistance of the resistors 1333-1335 may such that the net loss from the CATV port 1 to the gateway ports 1321-1324 is about 0 dB. The resistance of the resistors 1337-1339 may be such that the net loss from the gateway ports 1321-1324 to the CATV port 1 is about 0 dB. The input diplex filter 1220 and the output diplex filter 1240 may be similar to the diplex filter 14 described above with reference to FIG. 7, except that the high-pass sections 1222 and 1242 are tuned to have a cutoff frequency below the frequency band of the forward path, which is typically from 54, 85, or 102 MHz to 1002 or 1218 MHz, and the low-pass sections 1222 and 1242 are tuned to have a cutoff frequency above the frequency band of the forward path, which is typically from 5 MHZ to 42, 65, or 85 MHz. The input diplex filter 1220 and the output diplex filter 1240 may also be solid state or ceramic diplex filters as described above with reference to solid state or ceramic diplex filter 914 of FIG. 9.

Each of the splitters 4, 6, 24, and 1406 illustrated in FIGS. 12 and 13 may either hybrid splitters or resistive splitters. However, using one or more hybrid splitters 6 to connect each of the modem/gateway ports 8, 22, and/or 1321-1324 and a resistive splitter 24 to connect to each of the MoCA ports 25-28 has important technical benefits.

Hybrid splitters 6 are used to connect the modem/gateway ports 8, 22, and/or 1321-1324 to the common port of the diplex filter 14 or 914 because hybrid splitters 6 have lower insertion loss than a resistive splitter and the loss from the input to the modem/gateway devices needs to be minimized, since input signal levels from the service provider are a variable. By minimizing the insertion loss, using hybrid splitters 6 to connect the modem/gateway ports 8, 22, and/or 1321-1324 to the common port of the diplex filter 14 or 914 insures that a greater number of installation cases will have enough signal to function reliably. Additionally, hybrid splitters 6 have a higher port-to-port isolation than resistive splitters which, in the reverse path, is beneficial for adjacent gateway devices that have high transmit levels. Devices like modems, media gateways, and settop boxes that transmit signals upstream from the home to the cable office may transmit at high levels to overcome the splitter and tap losses in the outside distribution plant. Cable operators have found that if these devices are not sufficiently isolated from each other, distortion can occur that obscures the content of the signals. Since the hybrid splitter 6 can be optimized for high isolation (e.g., >35 dB) in the upstream band, it is the best choice to combine several of these loud talkers connected to the gateway splitter. Using hybrid splitters 6 to connect the modem/gateway ports 8, 22, and/or 1321-1324 to the common port of the diplex filter 14 or 914 also reduces losses in the path from the modem/gateway devices to the MoCA client devices, allowing the MoCA gateway splitter to accommodate additional MoCA client devices.

Resistive splitters 24, meanwhile, have lower port-to-port losses, allowing the MoCA gateway splitter to accommodate more MoCA client devices. A resistive splitter 24 is also more cost effective, in part because it requires no tuning. Using a resistive splitter 24 is also far simpler than hybrid splitters 6 as the number of ports increase. Finally, the resistive splitters 24 have wider bandwidth limitations, which may be important if the upper boundary of the MoCA band shifts upward. (As the CATV spectrum expands from 1002 to 1218 MHz with the adoption of DOCSIS 3, for example, the lower boundary of the MoCA band above it is pushed from 1125 to 1275 MHz, pushing the upper boundary of the MoCA band from 1675 to 1825 MHz.) The resistive splitter 24 is more tolerant of this kind of bandwidth expansion than hybrid splitters 6 due to its circuit simplicity.

As one of ordinary skill in the art would recognize, all of the component values described above are meant to illustrating rather than limiting. Additionally, one of ordinary skill in the art would recognize that features described with reference to separate embodiments may be combined. For example, the MoCA gateway splitter illustrated in FIG. 10 may be modified to incorporate the ceramic or solid state diplex 914 illustrated in FIG. 9.

The embodiments above have been described with reference to MoCA devices that communicate in the (higher) MoCA frequency spectrum, CATV signals in the (lower) CATV frequency spectrum, and gateway and modem devices that communicate in both the MoCA and CATV spectrum. However, the embodiments described above are not limited to MoCA and CATV devices. Instead, the embodiments described above are applicable to any system with devices that communicate in a high frequency spectrum, signals in a lower frequency spectrum, and devices that communicate over both the higher and lower frequency spectra.

The term “electrically connected” as used in the foregoing description and the following claims is not limited to a direct electrical connection but also includes indirect electrical connections through intermediate electrical components.

A “single diplex filter” as used in the foregoing description and the following claims means one low-pass filter and one high-pass filter with either a single port between the low-pass filter and the high-pass filter (as shown, for example, in FIGS. 1-4 and 7-9) or more than one port between the low-pass filter and the high-pass filter (as shown, for example, in FIG. 10). The low-pass filter and the high-pass filter may be integrated into a single discrete housing or component. Alternatively, the low-pass filter and the high-pass filter may each have their own discrete housing or component. In any of the above instances, the low-pass filter and the high-pass filter are electrically connected.

Although various embodiments of the invention have been shown and described, they are not meant to be limiting. Those of skill in the art may recognize certain modifications to these embodiments, which modifications are meant to be covered by the spirit and scope of the appended claims.

1. A MoCA (Multimedia over Coax Alliance) gateway splitter device, comprising:
a CATV (cable television) input port for receiving a CATV input signal;
a plurality of MoCA ports that are each connectable to a MoCA device;
a plurality of modem/gateway ports that are each connectable to a modem or gateway device;
a single diplex filter comprising a low-pass filter section and a high-pass filter section, wherein:
the CATV input port is electrically connected to the plurality of modem/gateway ports via the low-pass ‘filter section, enabling each modem or gateway device connected to the one of the plurality of modem/gateway ports to communicate with the CATV input port in a lower frequency band via the low-pass filter section;
the plurality of MoCA ports are electrically connected to the plurality of modem/gateway ports via the high-pass filter section, enabling each MoCA device connected to one of the plurality of MoCA ports to communicate with each modem/gateway port in a higher frequency band via the high-pass filter section; and
the diplex filter electrically isolates each of the plurality of MoCA ports from the CATV input port; and
an amplifier that amplifies the CATV input signal and provides the amplified CATV signal to the low-pass filter section of the diplex filter.

2. The device of claim 1, wherein the amplifier is a bidirectional amplifier that amplifies a return signals from the plurality of modem/gateway ports and provides the amplified return signals to the CATV input port.

3. The device of claim 2, wherein the bidirectional amplifier includes:
an input diplex filter with a high-pass section tuned to have a cutoff frequency below the frequency band of the CATV input signal and a low-pass section tuned to have a cutoff frequency above the frequency band of the return signals;
an output diplex filter with a high-pass section tuned to have a cutoff frequency below the frequency band of the CATV input signal and a low-pass section tuned to have a cutoff frequency above the frequency band of the return signals;
a forward path amplifier between the high-pass sections of the input diplex filter and the output diplex filter that amplifies the CATV input signal;
a return path amplifier between the low-pass sections of the input diplex filter and the output diplex filter that amplifies the return signals.

4. The device of claim 1, wherein the diplex filter is a ceramic or solid-state filter.

5. The device of claim 1, wherein the plurality of modem/gateway ports are electrically connected to the diplex filter via a hybrid splitter.

6. The device of claim 1, wherein the plurality of modem/gateway ports are electrically connected to a common port of the diplex filter that is electrically connected to both the low-pass filter section and the high-pass filter section.

7. The device of claim 1, wherein each of the plurality of MoCA ports are electrically connected to the high-pass filter section of the diplex filter via a resistive splitter.

8. The device of claim 1, further comprising a passive voice over internet protocol (VoIP) port electrically connected to the CATV input port via a hybrid splitter, wherein the CATV input port is electrically connected to the low-pass filter section of the diplex filter via the hybrid splitter.

9. (canceled)

10. The device of claim 1, wherein the device provides the ability for a MoCA device connected to one of the plurality of MoCA ports to program a gateway device connected to one of h plurality of gateway or modem ports to record CATV programs for later viewing.

11. A method of manufacturing a MoCA (Multimedia over Coax Alliance) gateway splitter device, the method comprising:
providing an CATV (cable television) input port for receiving a CATV input signal;
providing an amplifier that amplifies the CATV input signal;
providing a plurality of MoCA ports that are each connectable to a MoCA device;
providing a plurality of modem/gateway ports that are each connectable to a modem or gateway device;
providing a single diplex filter comprising a low-pass filter section and a high-pass filter section;
electrically connecting the amplifier to the plurality of modem/gateway ports via the low-pass filter section, enabling each modem or gateway device connected to one of the plurality of modem/gateway ports to communicate with the CATV input port in a lower frequency band via the low-pass filter section; and
electrically connecting the plurality of MoCA ports to the plurality of modem/gateway ports via the high-pass filter section, enabling each MoCA device connected to one of the plurality of MoCA ports to communicate with each modem/gateway port in a higher frequency band via the high-pass filter section,
wherein the diplex filter electrically isolates each of the plurality of MoCA ports from the CATV input port.

12. The method of claim 11, wherein the amplifier is a bidirectional amplifier that amplifies a return signals from the plurality of modem/gateway ports and provides the amplified return signals to the CATV input port.

13. The method of claim 12, wherein the bidirectional amplifier includes:
an input diplex filter with a high-pass section tuned to have a cutoff frequency below the frequency band of the CATV input signal and a low-pass section tuned to have a cutoff frequency above the frequency band of the return signals;
an output diplex filter with a high-pass section tuned to have a cutoff frequency below the frequency band of the CATV input signal and a low-pass section tuned to have a cutoff frequency above the frequency band of the return signals;
a forward path amplifier between the high-pass sections of the input diplex filter and the output diplex filter that amplifies the CATV input signal;
a return path amplifier between the low-pass sections of the input diplex filter and the output diplex filter that amplifies the return signals.

14. The method of claim 11, wherein the diplex filter is a ceramic or solid-state filter.

15. The method of claim 11, wherein the plurality of modem/gateway ports are electrically connected to the diplex filter via a hybrid splitter.

16. The method of claim 11, wherein the plurality of modem/gateway ports are electrically connected to a common port of the diplex filter that is electrically connected to both the low-pass filter section and the high-pass filter section.

17. The method of claim 11, wherein each of the plurality of MoCA ports are electrically connected to the high-pass filter section of the diplex filter via a resistive splitter.

18. The method of claim 11, further comprising:
providing a passive voice over internet protocol (VoIP) port; and
electrically connecting the passive VoIP port to the CATV input port via a hybrid splitter,
wherein the CATV input port is electrically connected to the low-pass filter section of the diplex filter via the hybrid splitter.

19. (canceled)

20. The method of claim 11, wherein the MoCA gateway device is manufactured such that a MoCA device connected to one of the plurality of MoCA ports can program a gateway device connected to one of the plurality of gateway or modem ports to record CATV programs for later viewing.

21. A splitter device, comprising:
a lower spectrum input port for communicating in a lower frequency band;
a plurality of higher spectrum device port that are each connectable to a higher spectrum device that communicates in a higher frequency band;
a plurality of broad spectrum device ports that are each connectable to devices that communicate in both the lower frequency band and the higher frequency band;
a single diplex filter comprising a low-pass filter section and a high-pass filter section, wherein:
the input port is electrically connected to the broad spectrum device ports via the low-pass filter section, enabling each broad spectrum device connected to one of the plurality of broad spectrum device ports to communicate with the lower spectrum input port in the lower frequency band via the low-pass filter section;
the plurality of higher spectrum device ports are electrically connected to the plurality of broad spectrum device ports via the high-pass filter section, enabling each higher spectrum device connected to one of the plurality of higher spectrum device ports to communicate with each broad spectrum device port in the higher frequency band via the high-pass filter section; and
the diplex filter electrically isolates each the plurality of broad spectrum device ports from the lower spectrum input port; and
an amplifier that amplifies signals received from the lower spectrum input port and provides the amplified signals to the low-pass filter section of the diplex filter.

22. MoCA (Multimedia over Coax Alliance) gateway splitter device, comprising:
a CATV (cable television) input port for receiving a CATV input signal;
a plurality of MoCA ports that are each connectable to a MoCA device;
a plurality of modem/gateway ports that are each connectable to a modem or gateway device; and
only one diplex filter, the diplex filter comprising a low-pass filter section and a high-pass filter section, wherein:
the CATV input port is electrically connected to the plurality of modem/gateway ports via the low-pass filter section, enabling each modem or gateway device connected to one of the plurality of modem/gateway ports to communicate with the CATV input port in a lower frequency band via the low-pass filter section;
the plurality of MoCA ports are electrically connected to the plurality of modem/gateway ports via the high-pass filter section, enabling each MoCA device connected to one of the plurality of MoCA ports to communicate with each modem/gateway port in a higher frequency band via the high-pass filter section;
the diplex filter electrically isolates each of the plurality of MoCA ports from the CATV input port; and
an amplifier that amplifies the CATV input signal and provides the amplified CATV signal to the low-pass filter section of the diplex filter.
